(19) United States
(12) Patent Application Publication
(10) Pub. No.: US 2007/0204962 A1
(43) Pub. Date: Sep. 6, 2007

(54) Accelerated flameless evaporation system

(75) Inventors: Rodney Hauser, Alberta (CA); Guy Comeau, Alberta (CA); Swen Theil, Alberta (CA)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Leader Energy Services Corp., Calgary (CA)

(21) Appl. No.: 11/400,129

(22) Filed: Apr. 7, 2006

(30) Foreign Application Priority Data
Feb. 9, 2006 (CA) 2,535,968

(51) Int. Cl. B01D 1/14

(52) U.S. Cl. 159/4.01; 159/16.1; 159/901

(57) ABSTRACT

A flameless evaporator for vaporizing a liquid, comprising a tank for receiving the liquid to be vaporized thereinto; a manifold disposed in the tank for the flow of hot gas therethrough, the manifold having an inlet for the supply of the hot gas and an outlet for the discharge of the hot gas from the manifold; an inlet into the tank for the supply of the liquid thereinto for thermal contact with the manifold for heating and vaporizing the liquid; and a vapour outlet for the discharge of the vapour from the tank.

### FIELD OF THE INVENTION

The present invention relates to a flameless system for evaporating a liquid and, more particularly, to a flameless evaporator in which heat for vaporization of the liquid comes primarily from waste heat produced by a prime mover such as an internal combustion engine.

### BACKGROUND OF THE INVENTION

There are numerous operations that utilize a liquid, usually water, for various purposes and these operations produce significant quantities of waste water requiring disposal. If the water is clean, it can simply be disposed of on site or in downstream operations. However, particularly in oil and gas field operations, where significant quantities of water are actually produced from the well and are separated from the hydrocarbons on site, the water will normally contain contaminants that cannot be disposed of on the lease. It is then necessary to either transport the water to an approved disposal site, or boil off the water so that only the contaminated residue requires transport, which is much more efficient.

Present evaporators typically use a conventional burner housed on a vehicle or in a boiler building to generate and supply the heat necessary to boil away the liquid waste. Because conventional boilers use an open combustion process, any boiler building on a drilling site must be located at least 26 meters from the well head. This presents the disadvantage that the footprint of the lease must be enlarged accordingly and more tubing is required to deliver the waste water to the boiler with attendant insulation issues necessary to prevent the liquid from freezing in the winter or from cooling excessively during transport at other times, which increases the amount of energy needed to initiate evaporation.

Open flame combustion boilers have a number of additional disadvantages, most notably open flame systems require substantial amounts of fuel and at current energy prices, it quickly becomes uneconomical to boil off liquid wastes.

### SUMMARY OF THE INVENTION

The present invention seeks to overcome the above disadvantages by providing an evaporator that uses heat waste from an engine, which engine may or may not be dedicated to the evaporator, and transferring that heat to the liquid waste to produce vapour. In the present invention, heat can be transferred from the engine using a first heat exchanger to transfer heat from the engine coolant for pre-heating the waste. Some engines however such as turbines do not have circulatory cooling systems which obviates preheating. An exhaust heat exchanger can be used to transfer heat from the engine exhaust to the waste for evaporation. This allows the present system to recover more waste heat from the engine for greater efficiency. For permanent installations such as gas plants and compressor stations, the engine is preferably the kind of powerful motor or turbine used to compress natural gas or other hydrocarbons for delivery through pipelines. These engines, typified by models G3512, G3606 and G3612 from Caterpillar™ Corporation, produce exhaust stack temperatures that can exceed 400° C. For mobile installations, the heat source can be the engine from the truck or tractor that transports the evaporator.

The waste liquid will normally be water, but the use of the present system for vaporization of other liquid wastes is contemplated.

According to the present invention then, there is provided a flameless evaporator for vaporizing a liquid, comprising a tank for receiving said liquid to be vaporized thereinto; a manifold disposed in said tank for the flow of hot gas therethrough, said manifold having an inlet for the supply of said hot gas and an outlet for the discharge of said hot gas from said manifold; an inlet into said tank for the supply of said liquid thereinto for thermal contact with said manifold for heating and vaporizing said liquid; and a vapour outlet for the discharge of said vapour from said tank.

### BRIEF DESCRIPTION OF THE DRAWINGS

Preferred embodiments of the present invention will now be described in greater detail and will be better understood when read in conjunction with the following drawing in which:

FIG. 1 is a schematic flow diagram of a system for evaporating liquid using heat transferred from an internal combustion engine;

FIG. 2 is a perspective view of an alternative system for evaporating liquid; and

FIG. 3 is a perspective exploded view of a diverter valve forming part of the evaporators of FIG. 1 or 2.

### DETAILED DESCRIPTION OF A PREFERRED EMBODIMENT

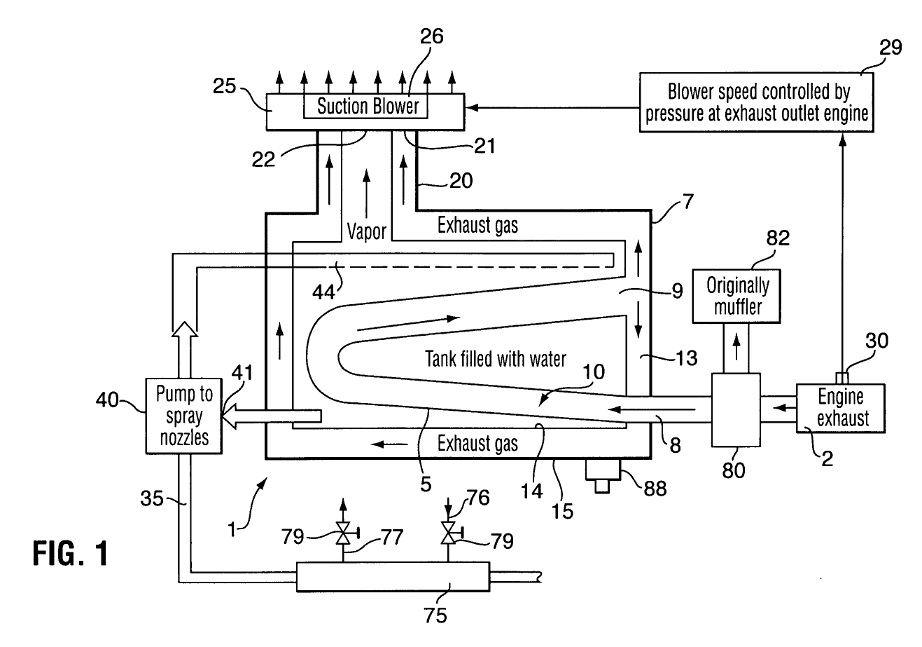

Referring now to FIG. 1, there is shown an apparatus for evaporating liquid using waste heat derived from an internal combustion engine's exhaust gases and/or engine coolant.

The core of the present system 1 is an evaporator tank 7 that will preferably be a double walled construction for purposes that will be described in greater detail below. Tank 7 incorporates a heat exchange system 10 that will typically include one or more lengths of continuous tubing 5 having one or more inlets 8 in fluid communication with a heat source 2. In this instance, the heat source is engine exhaust from a prime mover (not shown). As mentioned above, stations where for example large compressors are used to compress gas for transport through pipelines use powerful engines to operate the compressors, these engines expelling large quantities of waste heat. The heat is simply lost to atmosphere if no productive use is found for it. Water is a by product of the compressed gas and until now, there have been no commercially viable units that recycle the engine's waste heat to boil off the water. In another embodiment contemplated by the applicant, where the evaporator is mobile for transport from one place to another, the engine of the truck used to transport the evaporator can be the source of the exhaust gas used to vaporize the liquid. The prime mover can also be a dedicated engine mounted on a common sled with tank 7 for efficient transport, or in fact any other working engine on a site that can be tapped for its exhaust gases.

Tubing 5 can be arranged to exit through the upper wall of tank 7 to vent directly to the atmosphere, but more advantageously, tubing 5 will have one or more outlets 9 that discharge the exhaust gas into a zone 13 formed between inner and outer walls 14 and 15, respectively, of tank 7. Zone 13 therefore also forms part of heat exchange system 10.

Walls 14 and 15 culminate in an annular stack 20 having a first discharge 21 for the exhaust gas, and a second discharge 22 for escaping vapour. Stack 20 incorporates a housing 25 that encloses a suction blower 26. Blower 26 draws exhaust gas from the prime mover through the heat exchange system and also draws vapour from the tank's interior for more efficient dispersal. The blower's fan speed is advantageously controlled by a regulator 29 to maintain a lower pressure in heat exchange system 10 relative to the discharge pressure of exhaust gases from the prime mover. In this regard, regulator 29 receives signals from a pressure sensor 30 that measures exhaust pressure and responds to the signals to increase blower speed when the pressures are low and decrease blower speed when pressures are higher.

Waste water is supplied to tank 7 through a feed line 35 connected to pump 40. Pump 40 is connected in fluid communication to a manifold 44 that sprays the water over tubing 5. Pump 40 can include in a preferred embodiment a second inlet 41 in fluid communication with fluid already in tank 7 for recirculation of that fluid through manifold 44 for increased efficiency by separating the water into smaller droplets that are more easily heated or by reducing surface tension.

In another embodiment contemplated by the applicant, pump 40 is used solely for recirculation, and a separate pump (not shown) is used to supply water either directly into the tank's interior, or into the tank's interior through manifold 44.

Advantageously, the water is pre-heated prior to discharge into tank 7 using a heat exchanger 75 connected to the prime mover's heating system. Hot coolant from the engine flows through line 76 into the heat exchanger, which can be a shell and tube heat exchanger well known in the art, and returns to the engine via line 77. One or both of lines 76 and 77 can include a valve 79 to control the flow of coolant through heat exchanger 75.

The exhaust gas inlet is equipped with a three-way valve 80. When the exhaust gas is required for vaporization of waste, valve 80 is opened to direct the flow of gas into heat exchange system 10. If the system isn't being used, valve 80 is closed to divert the exhaust through a muffler 82 and then into the atmosphere.

In operation, valve 80 is opened to direct exhaust gases into heat exchange system 10 and valves 79 on heat exchanger 75 are opened to commence the flow of hot coolant. Waste water is then pumped through supply line 35 and is pre-heated by heat exchanger 75. The water is then discharged into the interior of tank 7 through manifold 44. Heat is transferred to the water by tubes 5 and from the tank's inner wall 14 to cause vaporization. The vapour is then vented through outlet 22 for discharge into the atmosphere.

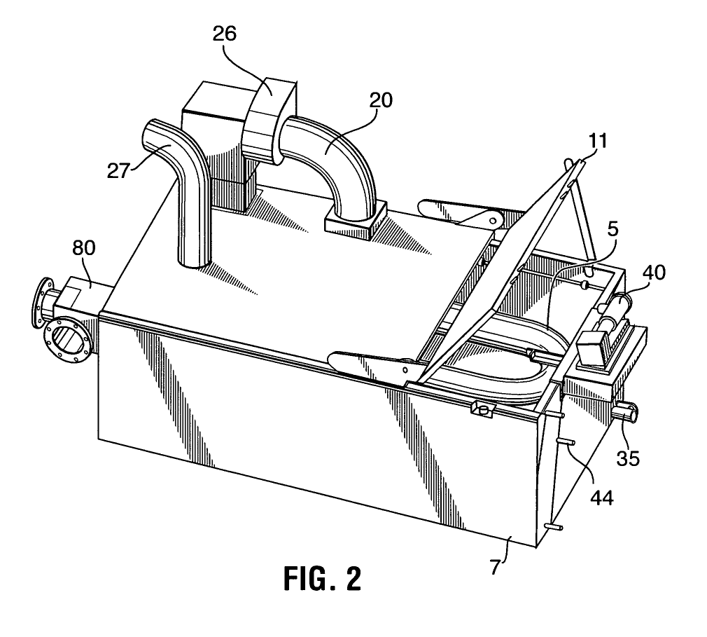

Tank 7 will preferably be insulated to prevent heat loss and will also include a hatch 11 (FIG. 2) for cleanout, and a drain 88 for removal of residual fluids.

FIG. 2 shows a somewhat simplified evaporator where like elements have been identified using like numerals. In this embodiment, tank 7 is insulated but lacks zone 13 to heat the tank walls from the inside. Exhaust gases enter tank 7 via valve 80 for circulation through tubing 5 and discharge through stack 20 assisted by suction blower 26. A separate stack 27 can be used for the discharge of vapour from the tank's interior.

Water is supplied to tank 7 via feed line 35 which is in fluid communication with pump 40 and manifold 44. In other respects, the evaporator is the same as the unit described with reference to FIG. 1.

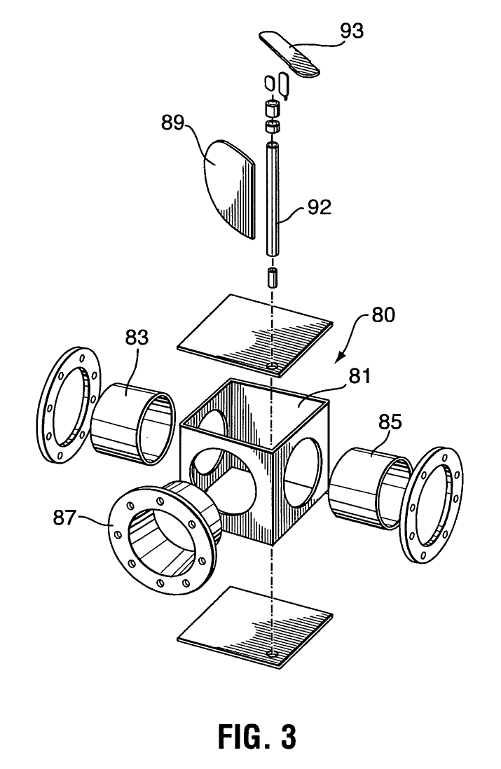

FIG. 3 is an exploded view of valve 80. The valve is in the nature of a diverter valve whose construction and operation will be readily apparent to the person skilled in the art and which will therefore be described only briefly. The valve includes a housing 81, an exhaust gas inlet 83, and two outlets, namely outlet 85 which connects to inlet 8 of tank 7, and an outlet 87 that will direct the exhaust gas to a muffler if the gas is to be directed away from tank 7. Outlets 85 and 87 are selected for opening or closing by a simple rotatable vane 89 mounted on a spindle 92 that can be rotated from outside housing 81 by handle 93.

The operation of the evaporator shown in FIG. 2 is substantially the same as the operation of the tank described above with reference to FIG. 1.

The above-described embodiments of the present invention are meant to be illustrative of preferred embodiments of the present invention and are not intended to limit the scope of the present invention. Various modifications, which would be readily apparent to one skilled in the art, are intended to be within the scope of the present invention. The only limitations to the scope of the present invention are set out in the following appended claims.

The embodiments of the invention in which an exclusive property or privilege is claimed are defined as follows:

1. A flameless evaporator for vaporizing a liquid, comprising:
a tank for receiving said liquid to be vaporized thereinto;
a manifold disposed in said tank for the flow of hot gas therethrough, said manifold having an inlet for the supply of said hot gas and an outlet for the discharge of said hot gas from said manifold;
an inlet into said tank for the supply of said liquid thereinto for thermal contact with said manifold for heating and vaporizing said liquid; and
a vapour outlet for the discharge of said vapour from said tank.

2. The evaporator of claim 1 wherein said outlet of said manifold includes blower means therein for drawing said hot gas through said manifold.

3. The evaporator of claim 2 wherein said blower reduces the pressure of said hot gas in said manifold relative to the pressure of said hot gas at said inlet to said manifold.

4. The evaporator of claim 3 wherein the speed of said blower is adjustable in response to changes in said pressure of said hot gas at said inlet to said manifold.

5. The evaporator of claim 4 wherein said blower additionally draws vapour from said tank for discharge therefrom.

6. The evaporator of claim 1 wherein said manifold comprises hollow tubing disposed within said tank.

7. The evaporator of claim 6 wherein said tank includes an inner and outer wall with a space therebetween, said space being in fluid communication with said hollow tubing to become part of said manifold for the flow of said hot gas therethrough.

8. The evaporator of claim 7 wherein said inlet to said manifold includes an adjustable valve operable to direct said hot gas into or away from said manifold.

9. The evaporator of claim 1 wherein said evaporator includes a pump for discharging said fluid into said tank.

10. The evaporator of claim 9 wherein said pump sprays said fluid onto said manifold.

11. The evaporator of claim 10 wherein said pump includes an additional inlet in fluid communication with said tank's interior for recirculating fluid accumulated in said tank through said pump and back into said tank for spraying onto said manifold.

12. The evaporator of claim 1 wherein said hot gas is exhaust from a prime mover.

13. The evaporator of claim 12 wherein said prime mover is an internal combustion engine.
